(19) United States
(12) Patent Application Publication
(10) Pub. No.: US 2007/0038932 A1
(43) Pub. Date: Feb. 15, 2007

(54) Multimedia entertainment system

(75) Inventor: Teng Feng Lin, San Chung City (TW)

Correspondence Address: LEONG C LEI, PMB # 1008, 1867 YGNACIO VALLEY ROAD, WALNUT CREEK, CA, 94598, US

(73) Assignee: EAST BEST CO., LTD.

(21) Appl. No.: 11/202,042

(22) Filed: Aug. 12, 2005

(51) Int. Cl. G06F 3/00

(52) U.S. Cl. 715/700

(57) ABSTRACT

The invention is about a system installed in a computer, which shares the same audio output and video display with the computer, and can function independently without turning on the computer. The invention mainly contains a main device connected between the computer's motherboard and laser disk drive. The main device, containing mainly a graphic processing unit and an audio processing unit', could access the laser disk drive directly, play the content of the laser disk inside, and conduct laser disk burning operation, all without turning on the computer.

### BACKGROUND OF THE INVENTION

(a) Technical Field of the Invention

The present invention generally relates to multimedia systems, and more particularly to a multimedia system installed in a computer capable of performing various multimedia tasks without turning on the computer.

(b) Description of the Prior Art Computers in households are moving away from their traditional roles of data crunching to become entertainment centers of the households, as the computers are already equipped with all the necessary gears for playing and recording AV programs from various sources. Unlike ordinary electrical appliances which can be turned on/off and become ready almost instantly, the computers would take a significantly longer period of time just to get started, let alone to start the appropriate application programs. For inexperienced users, these operation steps may even be quite daunting to them.

As such, some computer manufacturers provide a special kind of computers (notebooks or desktops) which can play the laser disk in the laser disk drive (such as DVD drive, CD-ROM drive, etc.) without turning on the computer and booting up the operating system. In other words, these computers function and operate just like ordinary disk players or similar appliances when the computers are not turned on. However, these appliance-like computers have to be specially designed and manufactured, and computers having such functionality usually cost a bundle.

### SUMMARY OF THE INVENTION

The primary purpose of the present invention is to provide a system for installation in an existing general computer and turning the computer into the aforementioned appliance-like computer.

The system mainly contains a main device connected between the computer's motherboard and laser disk drive. The main device, containing mainly a graphic processing unit and an audio processing unit, could access the laser disk drive directly, play the content of the laser disk inside, and conduct laser disk burning operation, all without turning on the computer.

The system further contains a display interfacing device so that both the computer and the main device could share a single display device. The display interfacing device is connected to the graphic processing unit, and contains a first connector for connecting to the video output port of the computer, and a second connector for connecting to a display device such as a CRT or LCD monitor.

The system further contains an AV (audio/video) interfacing device having appropriate audio and video input ports for receiving TV signals and radio broadcast signals from appropriate external sources so that the main device could store, process, or play them out on the display device and/or a speaker device. The AV interfacing device could also connect to game consoles such as PS2™ and Xbox™.

The system further contains an audio interfacing device having at least an audio output port for delivering audio signal to an external speaker device, and an audio input port for connecting to the computer's audio output. Similar to the video interfacing device, the audio interfacing device allows the computer and the main device to share a single speaker device.

The system could be fully integrated into the computer, could be operated from a wireless remote control without turning on the computer, and could optionally turn on and off the computer. The system could directly access the laser disk drive and conduct disk burning operations. The system could also be used to view TV programs on the computer's monitor, listen to radio programs on the computer's speakers, and play games by connecting to game consoles. Further, the system could also be used as a karaoke machine.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the various components of the multimedia entertainment system according to the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

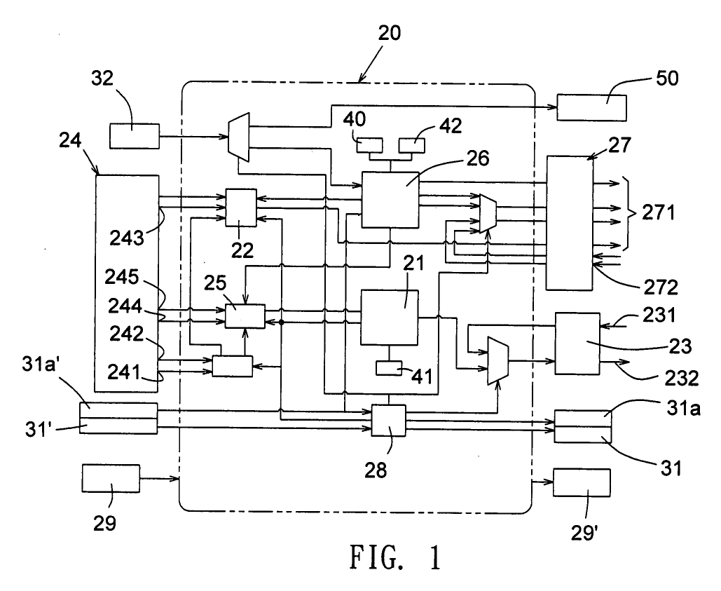

FIG. 1 is a schematic diagram showing the various components of the multimedia entertainment system according to the present invention. The multimedia entertainment system mainly contains a main device 20 which is installed, for example, in a free compartment of a desktop personal computer. As illustrated, the device 20, connected between the computer's motherboard 31 and an laser disk drive 32, contains a graphic processing unit 21 and an audio processing unit 22. When the device 20 is turned on, the device 20 could turn on the computer as well or operate independently. When the device 20 is on, even though the computer is remained off, it could directly activate the laser disk drive 32 and access the drive 32's laser disk. By the graphic and audio processing units 21 and 22, the multimedia content of the laser disk could be played on a display device and/or a speaker device, or a laser disk burning operation could be conducted on the laser disk driver 32.

The multimedia entertainment system further contains a display interfacing device 23, which is usually in the form of an adaptor card fixedly installed inside the computer. The display interfacing device 23 is connected to the output of the graphic processing unit 21. The display interfacing device 23 further contains a first connector 231 for connecting to the video output port (e.g., the VGA port) of the computer, and a second connector 232 for connecting to a display device (not shown) such as a CRT or LCD monitor. The major function of the display interfacing device 23 is that both the computer and the main device 20 could share a single display device.

The multimedia entertainment system further contains an AV (audio/video) interfacing device 24, which is usually in the form of an adaptor card fixedly installed inside the computer. The AV interfacing device 24 is connected to the inputs of the graphic and audio processing units 21 and 22 so that external TV signals and radio broadcast signals could be received via appropriate ports 241 and 242 respectively and delivered to the graphic and audio processing units 21 and 22. The major function of the AV interfacing device 24 is to allow the main device 20 to play TV and radio programs.

The AV interfacing device 24 further contains an audio input port (such as a microphone terminal 243) and video input ports (such as a S-VIDEO terminal 244 and AV-IN terminal 245) for connecting to external AV equipments such as a stereo, a camcorder, a game console, etc.

The main device 20 further contains a video decoder unit 25 connected between the AV interfacing device 24 and the graphic processing unit 21, so that video signals input from the AV interfacing device 24 are decoded and delivered to the graphic processing unit 21.

The main device 20 further contains a laser disk decoder unit 26 connected to the output of the laser disk drive 32, so that the multimedia content on the laser disk is decoded and delivered to the graphic and audio processing units 21 and 22, which in turn send the decoded video signal to the foregoing display interfacing device 23, and the decoded audio signal to an audio interfacing device 27.

The audio interfacing device 27 is usually in the form of an adaptor card fixedly installed inside the computer. The audio interfacing device 27 is connected to the outputs of the aforementioned audio processing unit 22 and the laser disk decoder unit 26. The audio interfacing device 27 contains at least an audio output port (such as a SPDIF fiber terminal 271) for delivering audio signal to an external speaker device, and an audio input port 272 for connecting to the computer's audio output. Similar to the video interfacing device 23, the audio interfacing device 27 allows the computer and the main device 20 to share a single speaker device.

The laser disk decoder unit 26 is connected to a memory unit (such as a ROM chip 40) having AV player program stored inside, so that the main device 20 could play various laser disks without turning on the computer.

The main device 20 further contains a micro controller unit 28 connected between the motherboard 31 and a control circuit 31′of the motherboard 31 so that the main device could decide whether to provide electrical power to the motherboard 31 (i.e., whether to turn on the computer).

The main device 20 further contains a power input port 29 for connecting to an external electrical power source, and at least a power output port 29′for passing electricity to relevant devices such as the laser disk drive 32. As such, the main device 20 is able to activate relevant devices without turning on the computer.

The multimedia entertainment system described above could convert analog input signals into digital forms for output or storage; or it could convert digital input signals into analog forms for output or storage, so that it could be connected to various types of external signal sources and devices.

The operation of the multimedia entertainment system is controlled by a wireless remote controller (not shown) whose radio control signals are received by a sensor unit 31a′ and delivered to the micro controller unit 28 for processing. The current operation status is displayed to the users in a status display window 3la connected to the micro controller unit 28. The status display window 31a could be text-based, graphic-based, or both.

The main device 20 further contains a number of memory units 41 and 42 connected to the graphic processing unit 21 and the laser disk decoder unit 26 respectively for the storage of operation data. These memory units 41 and 42 could be a synchronous dynamic RAM (SDRAM) or of other appropriate types of memory.

The main device 20 further contains a disk output port (such as an IDE terminal 50) for connecting to a hard disk drive for information storage and retrieval.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multimedia entertainment system comprising a main device, said main device installed inside a computer and connected between said computer's motherboard and a laser disk drive, said main device comprising a graphic processing unit, an audio processing unit, and a player program so that said main device is able to access said laser disk drive, play the content of a laser disk stored in said laser disk drive, and conduct disk burning operation.

2. The multimedia entertainment system according to claim 1, further comprising a display interfacing device fixedly installed inside said computer, said display interfacing device connected to the output of said graphic processing unit, said display interfacing device further comprising a first connector for connecting to the video output port of said computer, and a second connector for connecting to a display device.

3. The multimedia entertainment system according to claim 1, further comprising an AV (audio/video) interfacing device fixedly installed inside said computer, said AV interfacing device connected to the inputs of said graphic and said audio processing units so that external TV signals and radio broadcast signals are received via appropriate ports of said AV interfacing device respectively and delivered to sad graphic and audio processing units.

4. The multimedia entertainment system according to claim 3, wherein said ports of said AV interfacing device flier comprises a microphone terminal, a S-VIDEO terminal, and an AV-IN terminal.

5. The multimedia entertainment system according to claim 3, wherein said main device further comprises a video decoder unit connected between said AV interfacing device and said graphic processing unit so that video signals input from said AV interfacing device are decoded and delivered to said graphic processing unit.

6. The multimedia entertainment system according to claim 1, wherein said main device flier comprises a laser disk decoder unit connected to the output of said laser disk drive so that the multimedia content on a laser disk in said laser disk drive is decoded and delivered to said graphic and audio processing units.

7. The multimedia entertainment system according to claim 6, further comprising an audio interfacing device fixedly installed inside said computer, said audio interfacing device connected to said main device, and said audio interfacing device comprising at least an audio output port for sending out audio signals to a speaker device.

8. The multimedia entertainment system according to claim 7, wherein said audio interfacing device contains at least an audio input port for connecting to the audio output of said computer.

9. The multimedia entertainment system according to claim 1, wherein said main device further contains a micro controller unit connected between said motherboard and a control circuit of said motherboard so that said main device is able to decide whether to provide electrical power to said motherboard.

10. The multimedia entertainment system according to claim 1, wherein said main device further contains a power input port for connecting to an external electrical power source, and at least a power output port for passing electricity to relevant devices of said system.

11. The multimedia entertainment system according to claim 1, wherein said main device further contains a plurality of memory units connected to said graphic processing unit and said audio processing unit for the storage of operation data.

12. The multimedia entertainment system according to claim 1, wherein said main device further contains a disk output port for connecting to a hard disk drive for information storage and retrieval.

13. The multimedia entertainment system according to claim 1, wherein the operation of said system is controlled by a wireless remote controller whose radio control signals are received by a sensor unit of said main device and delivered to a micro controller unit for processing, and said micro controller unit shows the current operation status information in a status display window, which could be text-based, graphic-based, or both.
